(19) United States
(12) Patent Application Publication
(10) Pub. No.: US 2026/0019013 A1
(43) Pub. Date: Jan. 15, 2026

(54) MOTOR DRIVE CONTROL DEVICE

(71) Applicant: Panasonic Intellectual Property Management Co., Ltd., Osaka (JP)

(72) Inventors: YUKI NAKATSUKA, Osaka (JP); KENJI NAMBA, Osaka (JP)

(21) Appl. No.: 19/334,014

(22) Filed: Sep. 19, 2025

Related U.S. Application Data
(63) Continuation of application No. PCT/JP2024/009878, filed on Mar. 13, 2024.

(30) Foreign Application Priority Data
Apr. 5, 2023 (JP) 2023-061304

(51) Int. Cl. H02P 6/24; H02P 6/17

(52) U.S. Cl. CPC H02P 6/24; H02P 6/17

(57) ABSTRACT

A motor drive control device includes: a first input unit to which first current from the power source to the control unit is input; a first output unit that outputs the first current input from the first input unit to the control unit; a shutoff unit that is provided between the first input unit and the first output unit, and switches an output state of the first output unit; a second input unit to which second current from the control unit to the motor is input; a second output unit that outputs the second current input from the second input unit to the motor; and an arithmetic unit that is provided between the second input unit and the second output unit, and calculates a rotation speed of the motor.

### TECHNICAL FIELD

The present disclosure relates to a motor drive control device that performs drive control and monitoring of a motor.

### BACKGROUND ART

Some conventional control devices relating to brushless DC motor drive include, as a configuration, a driver circuit acting on an inverter circuit (see, for example, PTL 1). In a shutoff device and a diagnosis device configured by such a control device, abnormality detection and motor drive stop at the time of abnormality are performed using a control signal from the driver circuit.

### CITATION LIST

### Patent Literature

PTL 1: Japanese Patent No. 6429903

### SUMMARY OF THE INVENTION

However, in the technique of PTL 1, since a shutoff device and a diagnosis device are connected to a driver circuit, there is a problem that it is necessary to change the specifications of the shutoff device and the diagnosis device according to the specifications of the driver circuit.

The present disclosure has been made to solve such a problem, and an object of the present disclosure is to provide a motor drive control device that performs abnormality detection and motor drive stop at the time of abnormality regardless of the driver circuit.

In order to solve the above problem, one aspect of a motor drive control device according to the present disclosure is a motor drive control device that controls a motor with respect to a drive body driven by a control unit that receives power supply from a power source and controls the motor, the motor drive control device including: a first input unit to which first current from the power source to the control unit is input; a first output unit that outputs the first current input from the first input unit to the control unit; a shutoff unit that is provided between the first input unit and the first output unit, and switches an output state of the first output unit; a second input unit to which second current from the control unit to the motor is input; a second output unit that outputs the second current input from the second input unit to the motor; and an arithmetic unit that is provided between the second input unit and the second output unit, and calculates a rotation speed of the motor.

According to the present disclosure, abnormality detection and motor drive stop at the time of abnormality can be performed regardless of a driver circuit.

### BRIEF DESCRIPTION OF THE DRAWINGS

FIG. 1 is a system block diagram illustrating a motor drive control device according to a first exemplary embodiment.

FIG. 2A is a flowchart indicating processing of a speed calculator of the first exemplary embodiment.

FIG. 2B is a flowchart indicating determination processing of a speed calculation method indicated in FIG. 2A.

FIG. 2C is a flowchart indicating processing of acquiring one cycle of current indicated in FIG. 2B.

FIG. 2D is a flowchart indicating speed calculation processing using a first speed calculation method.

FIG. 2E is a flowchart indicating speed calculation processing using a second speed calculation method.

FIG. 2F is a flowchart indicating processing of acquiring feature points in one cycle of voltage from a voltage value indicated in FIG. 2E.

FIG. 3 is a flowchart indicating another processing of the speed calculator of the first exemplary embodiment.

FIG. 4 is a diagram illustrating a detailed configuration of a power shutoff unit of the motor drive control device according to the first exemplary embodiment.

FIG. 5A is a flowchart indicating determination processing of a speed calculation method of a second exemplary embodiment.

FIG. 5B is a flowchart indicating speed calculation processing using a third speed calculation method.

FIG. 6 is a flowchart indicating speed calculation processing performed by a speed calculator of a third exemplary embodiment.

FIG. 7 is a system block diagram illustrating a motor drive control device of a fourth exemplary embodiment.

FIG. 8 is a system block diagram illustrating a motor drive control device of a fifth exemplary embodiment.

FIG. 9 is a system block diagram illustrating a motor drive control device of a sixth exemplary embodiment.

### DESCRIPTION OF EMBODIMENT

Hereinafter, exemplary embodiments of the present disclosure will be described with reference to the drawings. Note that, the exemplary embodiments to be described below each illustrate one specific example of the present disclosure. Therefore, the following exemplary embodiments provide numerical values, constituent elements, arrangement position and connection states of the constituent elements, steps and order of the steps, and the like, which are merely exemplified and are not intended to limit the present disclosure. Accordingly, among the constituent elements in the exemplary embodiments below, a constituent element not described in an independent claim will be described as an optional constituent element.

In addition, each of the drawings is a schematic diagram, and is not necessarily strictly illustrated. Note that, in each of the drawings, substantially the same configurations are denoted by the same reference marks to eliminate or simplify duplicated description.

### First Exemplary Embodiment

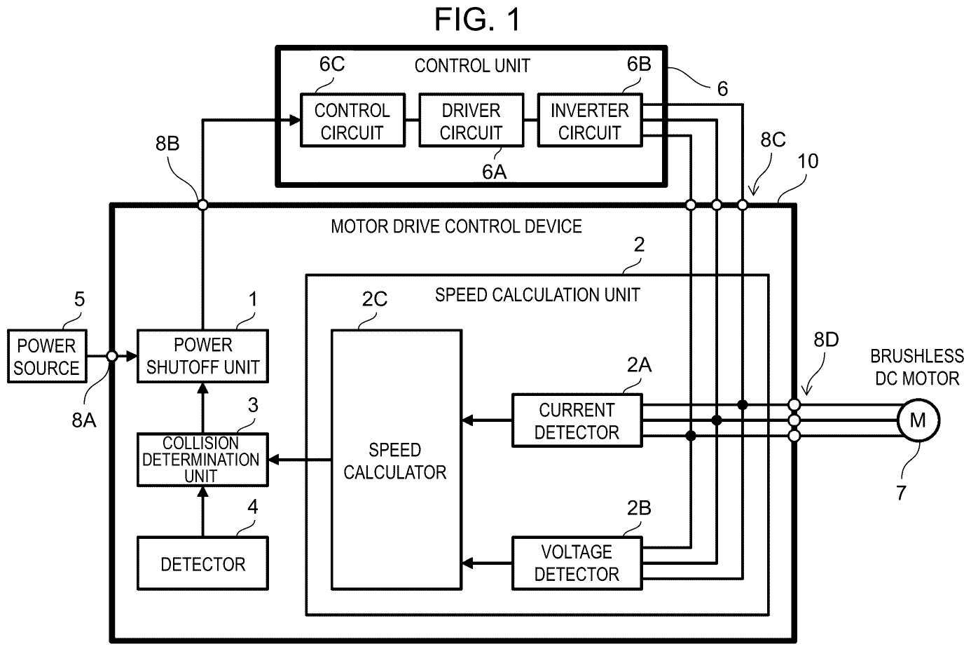

First, a configuration of a motor drive control device according to a first exemplary embodiment will be described. FIG. 1 is a system block diagram illustrating motor drive control device 10 according to the first exemplary embodiment. Targets of motor drive controlled by motor drive control device 10 of the present disclosure include power source 5, control unit 6, brushless DC motor 7, first input unit 8A, first output unit 8B, second input unit 8C, and second output unit 8D.

Power source 5 is, for example, a DC power source of a battery, current is input from power source 5 to first input unit 8A, the current is output from first output unit 8B to control unit 6, and power is supplied to control unit 6. Power source 5 may use an AC-DC converter. Control unit 6 includes driver circuit 6A, inverter circuit 6B, and control circuit 6C.

Driver circuit 6A is set using a control signal from control circuit 6C. Driver circuit 6A drives and controls switching elements of inverter circuit 6B such that a rotation speed and a rotation direction necessary for brushless DC motor 7 are obtained. The current that is a motor drive signal output from inverter circuit 6B is input to second input unit 8C, and the current is input from second output unit 8D to brushless DC motor 7.

Motor drive control device 10 includes power shutoff unit 1, speed calculation unit 2, collision determination unit 3, and detector 4. Power shutoff unit 1 shuts off the power supplied from power source 5 to control unit 6. Power shutoff unit 1 is configured to be able to shut off the power supply from power source 5 to control unit 6 in motor drive control device 10. Power shutoff unit 1 is, for example, a relay switch.

The motor drive signal output from control unit 6 to brushless DC motor 7 is input to speed calculation unit 2. Speed calculation unit 2 is an arithmetic unit including current detector 2A, voltage detector 2B, and speed calculator 2C.

Current detector 2A and voltage detector 2B are connected to a motor drive line, measure a current value and a voltage value of the motor drive line, respectively, and transmit the measured values to speed calculator 2C. It is desirable to use, for current detector 2A, a current sensor using the Hall effect so as not to affect the current value of the motor drive line, but current detector 2A may be a current sensor using a shunt resistor or the like. Voltage detector 2B is, for example, a voltage sensor using resistance voltage division or an operational amplifier.

Speed calculator 2C receives the current value from current detector 2A or the voltage value from voltage detector 2B, or both of the values to calculate the motor rotation speed, and may be, for example, a microcomputer. Note that speed calculation unit 2 may acquire and use a sensor signal from brushless DC motor 7 such as a Hall sensor or an encoder, or a motor speed command value acquired by connecting to driver circuit 6A of control unit 6.

Detector 4 is a device for acquiring environment information around a product, and is, for example, a Lidar, a TOF sensor, a camera, an ultrasonic sensor, an infrared sensor, or the like. Note that detector 4 may receive information from a control unit or a sensor located outside.

Collision determination unit 3 uses motor speed information from speed calculation unit 2 and the environment information from detector 4 to determine the possibility of collision between an obstacle and the motor drive target, and may be, for example, a microcomputer. In a case of determining that there is a possibility of collision, collision determination unit 3 transmits a signal to power shutoff unit 1.

When the signal is transmitted from collision determination unit 3, power shutoff unit 1 can stop brushless DC motor 7 by shutting off a power source line and making the power supply from power source 5 to control unit 6 to be shut off. Whether brushless DC motor 7 is stopped may be confirmed from the motor rotation speed calculated by speed calculation unit 2. Note that power shutoff unit 1 may stop brushless DC motor 7 using electromagnetic brake or by connecting to driver circuit 6A of control unit 6 and transmitting a motor stop signal. According to this configuration, drive control and monitoring of brushless DC motor 7 can be performed regardless of the internal specification of control unit 6.

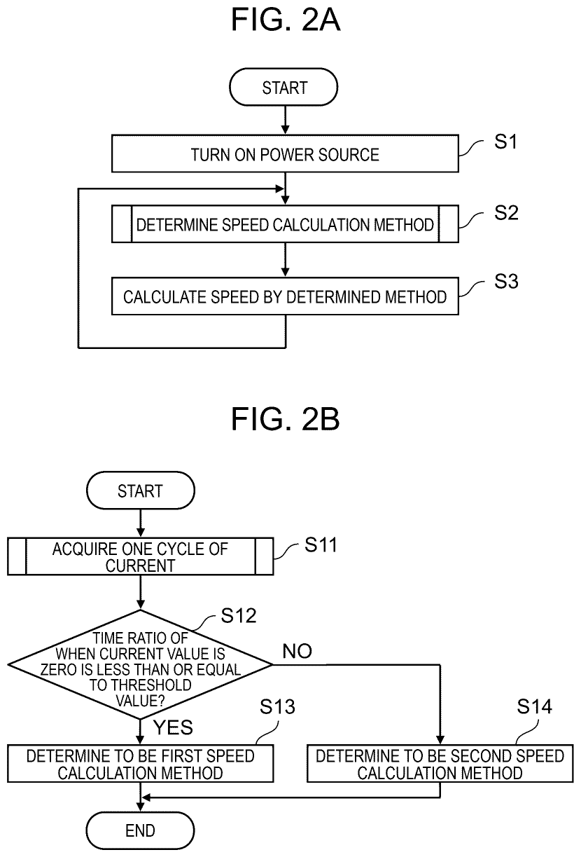

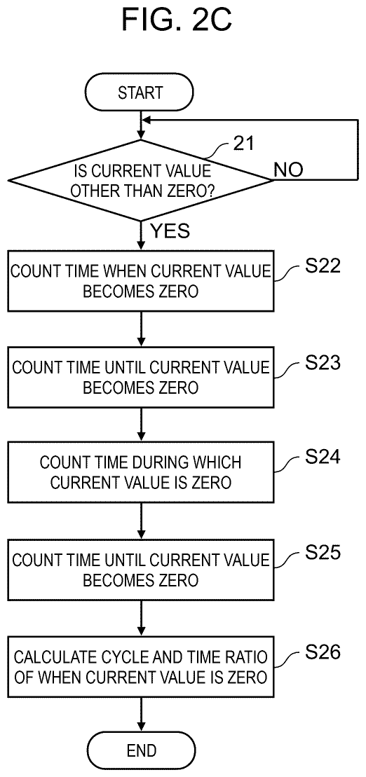

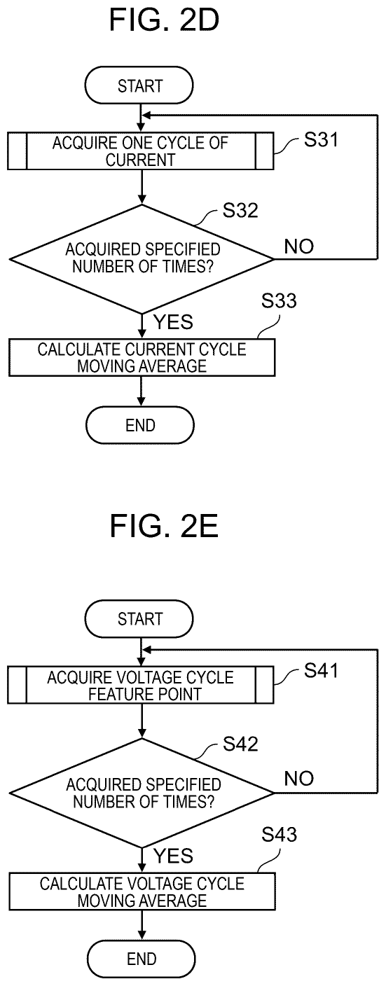

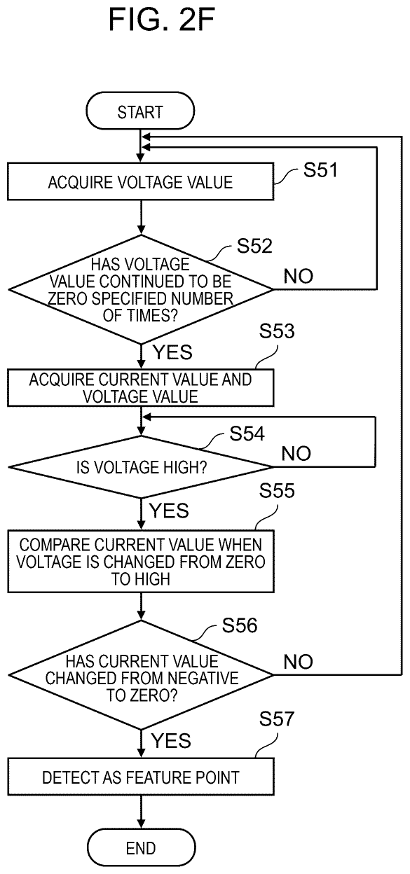

Next, processing of speed calculator 2C in the present exemplary embodiment will be described. FIG. 2A is a flowchart indicating processing of speed calculator 2C of the first exemplary embodiment. The first exemplary embodiment is characterized in that the speed calculation processing by speed calculation unit 2 includes processing of switching the speed calculation method based on the current value.

Speed calculator 2C performs switching processing of the speed calculation method using the current value transmitted from current detector 2A. Note that, in the speed calculation, the voltage value transmitted from voltage detector 2B may be used. In brushless DC motor 7, since the motor speed can be calculated by reading the current or voltage cycle of the motor drive line, the current or voltage cycle is calculated by, for example, the following processing flow.

After the power source is turned on (step S1), speed calculator 2C first determines the speed calculation method (step S2), and calculates the speed by the determined method (step S3).

Here, speed calculator 2C performs the processing of determining the speed calculation method only once while the power source is turned on and the current continues to be input from power source 5 to control unit 6.

FIG. 2B is a flowchart indicating the determination processing of the speed calculation method indicated in FIG. 2A. As indicated in FIG. 2B, in the flow of determining the speed calculation method, speed calculator 2C first acquires one cycle of the current (step S11).

FIG. 2C is a flowchart indicating processing of acquiring one cycle of the current indicated in FIG. 2B. As indicated in FIG. 2C, in order to acquire one cycle of the current, for example, in a case where the current value is other than zero (YES in step S21), speed calculator 2C counts the time during which the current value is zero with a moment when the current value becomes zero as a starting point (step S22). In addition, speed calculator 2C counts the time from when the current value changes from zero until the next time the current value becomes zero (step S23), counts the time during which the current value is zero again (step S24), and then measures the time from when the current value changes from zero until the next time the current value becomes zero (step S25).

Then, speed calculator 2C calculates one cycle by taking the sum of all the times, and further calculates a time ratio of when the current value is zero within one cycle (step S26). Thereafter, speed calculator 2C switches the speed calculation method based on the comparison result between the calculated time ratio and a threshold value.

Specifically, as illustrated in FIG. 2B, in a case where the time ratio is less than or equal to the threshold value (YES in step S12), speed calculator 2C determines the speed calculation method to be a first speed calculation method (step S13).

FIG. 2D is a flowchart indicating the speed calculation processing using the first speed calculation method. As indicated in FIG. 2D, speed calculator 2C acquires one cycle of the current by the method indicated in FIG. 2C (step S31).

Then, speed calculator 2C determines whether one cycle of the current has been acquired a specified number of times (step S32). In a case where one cycle has not been acquired the specified number of times (NO in step S32), speed calculator 2C performs the processing of step S31 until one cycle is acquired the specified number of times. Here, the processing in step S31 is the processing described in FIG. 2C.

In a case where one cycle of the current has been acquired the specified number of times (YES in step S32), speed calculator 2C calculates a moving average of one cycle of the current (step S33). For example, in a case where the motor is driven by a vector control method, the moving average of one cycle of the current is basically calculated by this calculation method, and the motor speed can be calculated from the moving average.

In FIG. 2B, in a case where the time ratio is larger than the threshold value (NO in step S12), speed calculator 2C determines the speed calculation method to be a second speed calculation method (step S14).

FIG. 2E is a flowchart indicating the speed calculation processing using the second speed calculation method. As indicated in FIG. 2E, speed calculator 2C acquires feature points in one cycle of the voltage from the voltage value (step S41).

Then, speed calculator 2C determines whether the feature points in one cycle of the voltage have been acquired a specified number of times (step S42). In a case where the feature points have not been acquired the specified number of times (NO in step S42), speed calculator 2C performs the processing of step S41 until the feature points are acquired the specified number of times.

In a case where the feature points have been acquired the specified number of times (YES in step S42), speed calculator 2C calculates the moving average of intervals between the feature points to acquire a voltage cycle (step S43), and can calculate the motor speed from the moving average.

FIG. 2F is a flowchart indicating processing of acquiring the feature points in one cycle of the voltage from the voltage value indicated in step S41 of FIG. 2E. As indicated in FIG. 2F, speed calculator 2C first acquires the voltage value (step S51).

Then, speed calculator 2C determines whether the voltage value has continued to be zero a specified number of times (step S52). In a case where the voltage value has not continued to be zero the specified number of times (NO in step S52), speed calculator 2C performs the processing of step S52 until the voltage value continues to be zero the specified number of times.

In a case where the voltage value has continued to be zero the specified number of times (YES in step S52), speed calculator 2C acquires the current value and the voltage value (step S53). Then, speed calculator 2C determines whether the voltage value has been switched from LOW to HIGH (step S54). In a case where the voltage value has not been switched from LOW to HIGH (NO in step S54), speed calculator 2C performs the processing of step S54 until the voltage value is switched.

In a case where the voltage value has been switched from LOW to HIGH (YES in step S54), speed calculator 2C compares the current value when the voltage is changed from zero to HIGH, with zero (step S55).

In a case where the current value has changed from negative to zero (YES in step S56), speed calculator 2C detects such a timing as a feature point (step S57). In a case where the current value has not changed from negative to zero (NO in step S56), the processing returns to step S51. In a case where the motor is driven by a square-wave control method, the motor speed can be calculated by such a calculation method that uses the feature points.

According to the above configuration, even in a case where the motor control method is unknown, the cycle can be calculated from the characteristic current-voltage behavior in each control method, and the accuracy of the motor speed calculation can be improved.

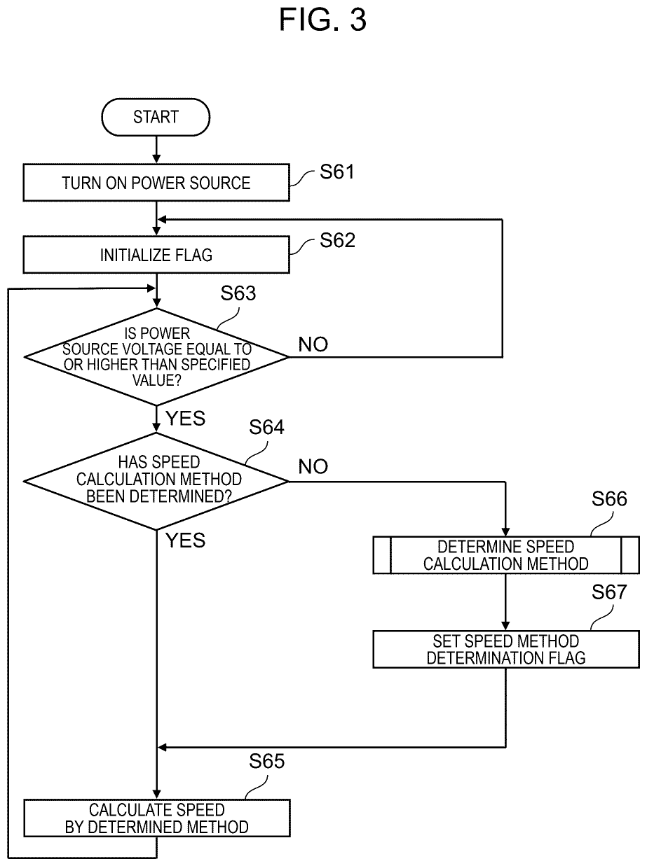

Next, another processing flow of speed calculator 2C will be described. FIG. 3 is a flowchart indicating another processing of speed calculator 2C of the first exemplary embodiment. The processing flow of FIG. 3 is characterized in that, in the speed calculation processing of speed calculation unit 2, the speed calculation method determination processing indicated in step S2 of FIG. 2A may be omitted according to a power source voltage value of the power source input unit.

After the power source is turned on (step S61), first, speed calculator 2C initializes a motor speed calculation method determination flag (step S62). The motor speed calculation method determination flag is a flag indicating whether the motor speed calculation method has been determined.

Then, speed calculator 2C determines whether the power source voltage is equal to or higher than the threshold value (step S63). In a case where the power source voltage is not equal to or higher than a specified value (NO in step S63), the processing from step S62 is performed.

In a case where the power source voltage is equal to or higher than the specified value (YES in step S63), speed calculator 2C refers to the motor speed calculation method determination flag and determines whether the motor speed calculation method has been determined (step S64).

In a case where the motor speed calculation method is undetermined (NO in step S64), speed calculator 2C determines the speed calculation method by, for example, the speed calculation method determination flow described above (step S66). When the speed calculation method is determined, the speed calculation method determination flag is set (step S67), and the speed calculation is performed by the determined speed calculation method (step S65).

Thereafter, since the speed calculation method determination flag is set while the power source voltage is equal to or higher than the specified value, speed calculator 2C omits the speed calculation method determination flow (YES in step S64). According to this configuration, while power source is continuously supplied from power source 5, the speed calculation method determination flow can be omitted, and the time required for speed calculation can be shortened.

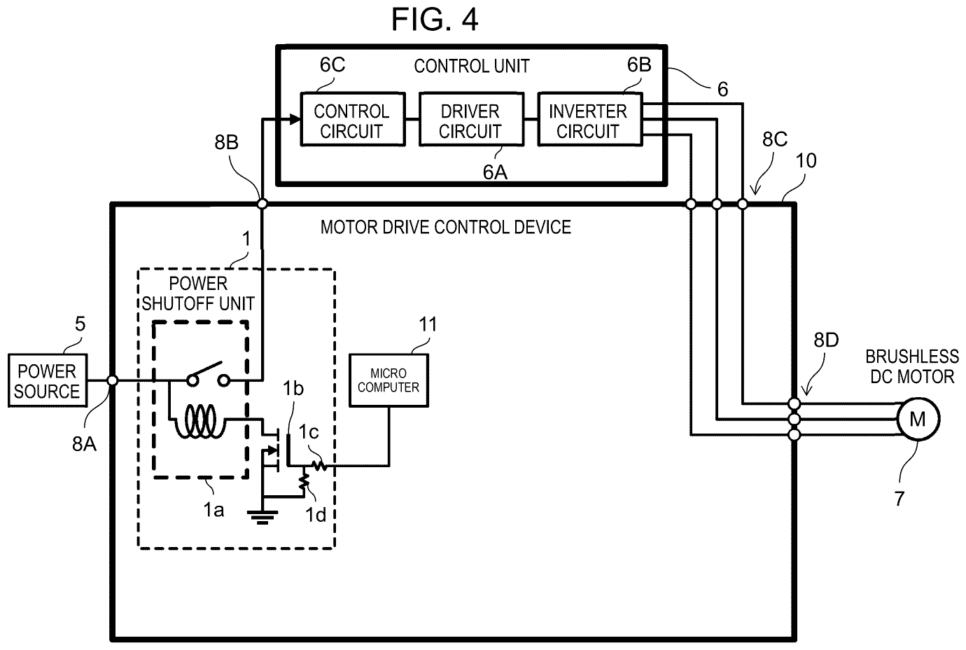

Next, a detailed configuration of power shutoff unit 1 of motor drive control device 10 according to the first exemplary embodiment will be described. FIG. 4 is a diagram illustrating the detailed configuration of power shutoff unit 1 of motor drive control device 10 according to the first exemplary embodiment. Note that, similarly to FIG. 1, motor drive control device 10 includes speed calculation unit 2, collision determination unit 3, and detector 4, which have the same configuration as that of FIG. 1, and thus illustration and description thereof are omitted.

Power shutoff unit 1 includes relay switch 1a, NchMOSFET 1b, gate resistor 1c, and gate-source resistor 1d. Relay switch 1a can be controlled by microcomputer 11 by, for example, connecting the HIGH side to the power source line, connecting the LOW side to the drain of NchMOSFET 1b, and connecting the gate of NchMOSFET 1b to microcomputer 11.

According to this configuration, at the time of abnormality, microcomputer 11 can switch the connection state of relay switch 1a to shut off the power supply from power source 5 to control unit 6, and brushless DC motor 7 can be stopped.

### Second Exemplary Embodiment

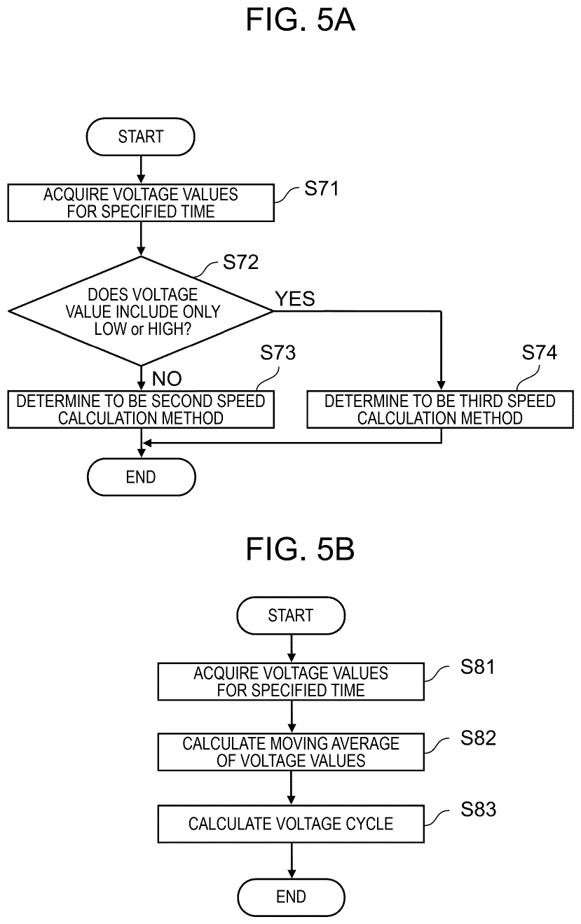

Next, determination processing of a speed calculation method of a motor rotation speed according to a second exemplary embodiment will be described. FIG. 5A is a flowchart indicating the determination processing of the speed calculation method of the second exemplary embodiment. Different from the first exemplary embodiment, the second exemplary embodiment is characterized in that the speed calculation method is switched based on a voltage value in speed calculation method determination processing performed by speed calculation unit 2. Note that configurations that are not particularly mentioned, such as a system configuration, are the same as those in the first exemplary embodiment, and description thereof will be omitted.

Speed calculator 2C performs switching processing of the speed calculation method using the voltage value transmitted from voltage detector 2B. Note that, in the speed calculation, speed calculator 2C may use the current value transmitted from current detector 2A. In brushless DC motor 7, since the motor speed can be calculated by reading the current or voltage cycle of the motor drive line, speed calculator 2C calculates the current or voltage cycle by, for example, the following processing flow.

First, speed calculator 2C acquires voltage values for a specified time (step S71), and determines whether the acquired voltage values include only two types of HIGH level and LOW level, or include an intermediate value thereof (step S72).

In a case where the acquired voltage values are only two types of HIGH level and LOW level (YES in step S72), speed calculator 2C determines the speed calculation method to be a third speed calculation method (step S74).

FIG. 5B is a flowchart indicating the speed calculation processing using the third speed calculation method. As indicated in FIG. 5B, speed calculator 2C acquires the voltage values for a specified time (step S81), and calculates a moving average of the voltage values (step S82). Then, speed calculator 2C calculates the cycle of the voltage from the moving average of the voltage values (step S83). For example, in a case where the motor is driven by a vector control method, the voltage cycle can be calculated by this calculation method, and the motor speed can be calculated.

In step S72 of FIG. 5A, in a case where the acquired voltage values include not only HIGH level and LOW level but also the intermediate value (NO in step S72), speed calculator 2C determines the speed calculation method to be a second speed calculation method (step S73).

In this case, as described with reference to FIG. 2E, speed calculator 2C acquires feature points in one cycle of voltage from the voltage value (step S41), acquires the feature points a specified number of times (YES in step S42), then acquires the voltage cycle by calculating the moving average of the intervals (step S43), and calculates the motor speed.

Here, for acquisition of the feature points in one cycle of the voltage, for example, there is a method in which the timing at which the voltage value is switched from LOW to HIGH and the current value is changed from negative to zero is used as the feature point. In a case where the motor is driven by a square-wave control method, the motor speed can be calculated by this calculation method. According to the above configuration, even in a case where the motor control method is unknown, the cycle can be calculated by extracting the characteristic voltage behavior in each control method, and the accuracy of the motor speed calculation can be improved.

### Third Exemplary Embodiment

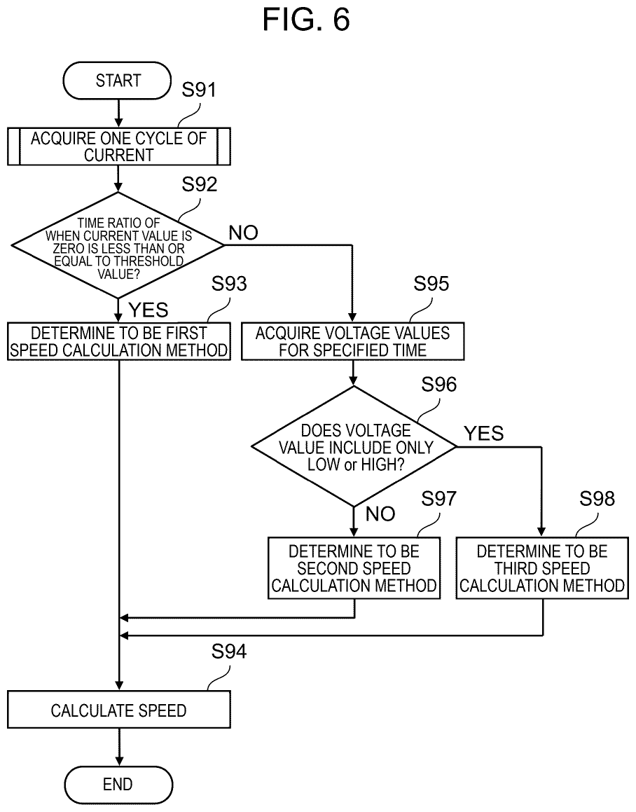

In a third exemplary embodiment, switching processing of a speed calculation method by a current value and switching processing of the speed calculation method by a voltage value are used in combination. That is, both the first exemplary embodiment and the second exemplary embodiment may be implemented. This processing is performed by, for example, the flow indicated in FIG. 6.

FIG. 6 is a flowchart indicating speed calculation processing performed by speed calculator 2C of the third exemplary embodiment. Speed calculator 2C performs the switching processing of the speed calculation method using the current value transmitted from current detector 2A.

First, after the power source is turned on, speed calculator 2C determines the speed calculation method. For this purpose, speed calculator 2C first acquires one cycle of current (step S91).

As a method of acquiring one cycle of the current, for example, as described with reference to FIG. 2C, there is a method of calculating one cycle by, with a moment when the current value becomes zero as a starting point, measuring a time during which the current value is zero, a time from when the current value changes from zero until the next time the current value becomes zero, a time during which the current value is zero again, and a time from when the next time the current value changes from zero again until the next time the current value becomes zero, and calculating a sum of all the times.

After acquiring one cycle of the current, speed calculator 2C calculates a time ratio of when the current value is zero within one cycle. Thereafter, speed calculator 2C determines whether the calculated time ratio is less than or equal to a threshold value (step S92).

In a case where the time ratio is less than or equal to the threshold value (YES in step S92), speed calculator 2C determines the speed calculation method to be a first speed calculation method (step S93).

In the first speed calculation method, as described with reference to FIG. 2D, speed calculator 2C acquires one cycle of the current a specified number of times (YES in step S32), and calculates a moving average of one cycle of the current (step S33).

In a case where the motor is driven by a vector control method, speed calculator 2C basically calculates one cycle by this calculation method, and calculates the motor speed the calculation result (step S94).

In a case where the time ratio is larger than the threshold value (NO in step S92), speed calculator 2C performs the switching processing of the speed calculation method using the voltage value transmitted from voltage detector 2B.

Specifically, speed calculator 2C acquires voltage values for a specified time (step S95), and determines whether the acquired voltage values include only two types of HIGH level and LOW level, or include an intermediate value thereof (step S96).

In a case where the acquired voltage values are only two types of HIGH level and LOW level (YES in step S96), speed calculator 2C determines the speed calculation method to be a third speed calculation method (step S98).

In the third speed calculation method, as described with reference to FIG. 5B, speed calculator 2C acquires the voltage values for a specified time (step S81), calculates a moving average of the voltage values (step S82), and calculates a cycle of the voltage (step S83).

For example, in a case where the motor is driven by the vector control method and the current value is small and the time ratio is larger than the threshold value in the time ratio determination of when the current value is zero in one cycle of the current value, speed calculator 2C calculates the voltage cycle by this calculation method and calculates the motor speed (step S94).

In a case where the acquired voltage values include not only HIGH level and LOW level but also the intermediate value (NO in step S96), speed calculator 2C determines the speed calculation method to be a second speed calculation method (step S97).

In the second speed calculation method, as described with reference to FIG. 2E, speed calculator 2C acquires feature points in one cycle of voltage from the voltage value (step S41), acquires the feature points a specified number of times (YES in step S42), and then acquires the voltage cycle by calculating the moving average of the intervals (step S43).

Then, speed calculator 2C calculates the motor speed from the acquired voltage cycle (step S94).

As a method for acquiring the feature points in one cycle of the voltage, for example, there is a method in which the timing at which the voltage value is switched from LOW to HIGH and the current value is changed from negative to zero is used as the feature point. In a case where the motor is driven by a square-wave control method, the motor speed can be calculated by this calculation method.

Note that, in FIG. 6, processing order of the determination of the switching of the speed calculation method by the current value and the determination of the switching of the speed calculation method by the voltage value, may be changed. According to this configuration, even in a case where it is difficult to determine one of the characteristic current behavior and voltage behavior in each control method, the cycle can be calculated using the other value, and the accuracy of the motor speed calculation can be improved.

### Fourth Exemplary Embodiment

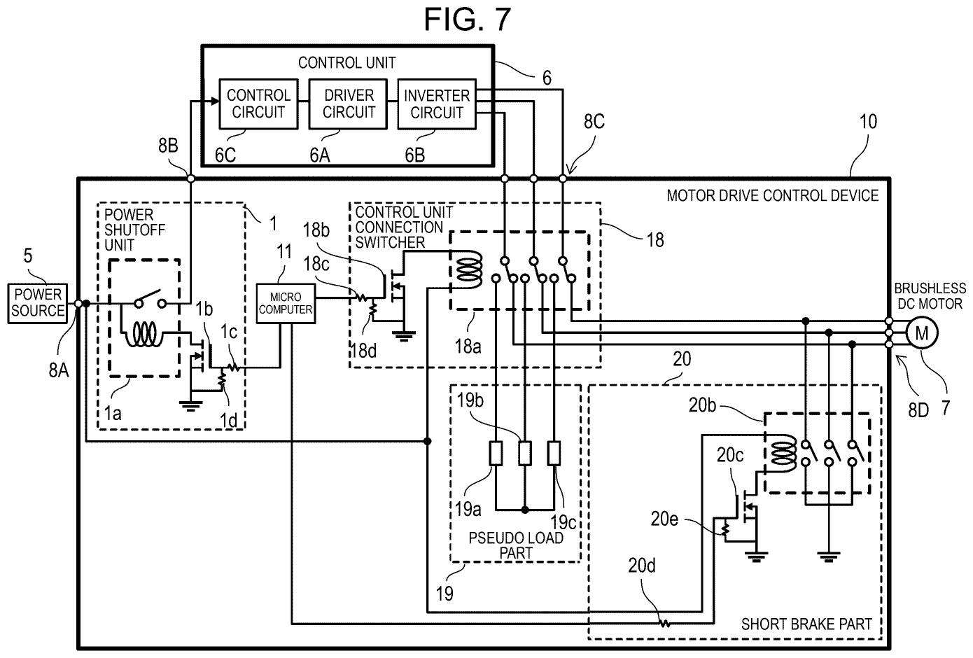

Next, a configuration of motor drive control device 10 according to a fourth exemplary embodiment will be described. FIG. 7 is a system block diagram illustrating motor drive control device 10 of the fourth exemplary embodiment. In FIG. 7, the configuration same as that of FIG. 4 is denoted by the same reference marks, and the description thereof will be omitted. Note that, similarly to FIG. 1, motor drive control device 10 includes speed calculation unit 2, collision determination unit 3, and detector 4, which have the same configuration as that of FIG. 1, and thus illustration and description thereof are omitted.

Different from the first exemplary embodiment, the fourth exemplary embodiment is characterized in that control unit connection switcher 18, pseudo load part 19, and a short brake part 20 are provided. With this configuration, control unit 6 originally provided in the motor drive target can prevent the occurrence of an error due to a change in the output destination.

Control unit connection switcher 18 includes relay switch 18a, NchMOSFET 18b, gate resistor 18c, and gate-source resistor 18d. Control unit connection switcher 18 switches the connection destination of the motor drive line, which is from control unit 6, from motor 7 to pseudo load part 19 in motor drive control device 10 at the same time as relay switch 1 a switches the connection state.

In the connection switching operation, it is desirable to switch the connection of all three layers of the motor drive line by one input, and an example of realizing such an operation includes relay switch 18a of a three-pole c-contact. Relay switch 18a can be controlled by microcomputer 11 by, for example, connecting the HIGH side to the power source line, connecting the LOW side to the drain of NchMOSFET 18b, and connecting the gate of NchMOSFET 18b to microcomputer 11.

Pseudo load part 19 connects the motor drive lines via a load simulating motor 7 in a manner similar to the connection state inside the motor. The pseudo load of the motor may be, for example, a resistor, and the pseudo load resistors 19a to 19c are used here.

Power shutoff unit 1 includes relay switch 1a, NchMOSFET 1b, gate resistor 1c, and gate-source resistor 1d. Relay switch 1a is a switch that can be controlled by microcomputer 11 by, for example, connecting the HIGH side to the power source line, connecting the LOW side to the drain of NchMOSFET 1b, and connecting the gate of NchMOSFET 1b to microcomputer 11.

With such a configuration, by performing the switching by control unit connection switcher 18 after the power shutoff by power shutoff unit 1, the influence of the motor drive signal output stop delay due to the electrolytic capacitor residual charge and the like inside control unit 6 can be reduced, and the time required for stopping motor 7 can be shortened.

Short brake part 20 connects the motor drive line on motor 7 side to GND after control unit 6 and motor 7 are disconnected from each other by control unit connection switcher 18. Short brake part 20 includes short brake switch 20b, NchMOSFET 20c, gate resistor 20d, and gate-source resistor 20c. The switching of the connection is performed by short brake switch 20b.

In the connection switching operation, it is desirable to switch the connection of all three layers of the motor drive line by one input, and an example of realizing such an operation includes a relay switch of a three-pole a-contact or a three-pole c-contact.

Short brake switch 20b can be controlled by microcomputer 11 by, for example, connecting the HIGH side to the power source line, connecting the LOW side to the drain of NchMOSFET 20c, and connecting the gate of NchMOSFET 20c to microcomputer 11.

With such a configuration, by connecting the motor drive line on motor 7 side to GND after control unit 6 and motor 7 are disconnected from each other by control unit connection switcher 18, the magnetic energy remaining in a coil in motor 7 can be released and further, motor 7 can be stopped quickly.

However, in order to prevent through-current inside control unit 6, it is desirable that the operation of short brake switch 20b be limited to a case where control unit connection switcher 18 disconnects control unit 6 and motor 7 from each other.

### Fifth Exemplary Embodiment

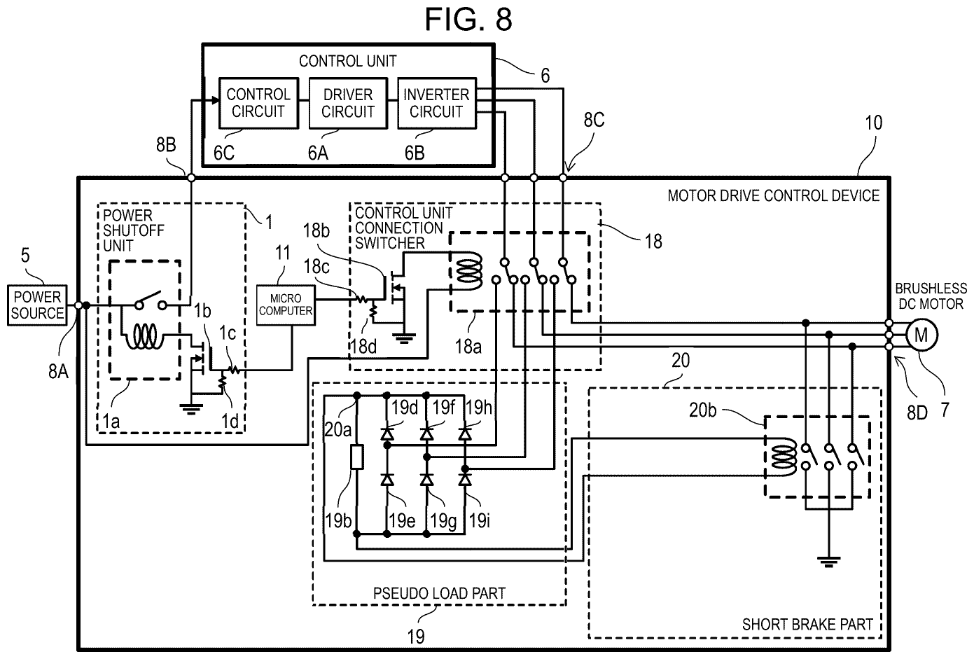

Next, a detailed configuration of motor drive control device 10 according to a fifth exemplary embodiment will be described. FIG. 8 is a system block diagram illustrating motor drive control device 10 of the fifth exemplary embodiment. In FIG. 8, the configuration same as that of FIG. 4 or FIG. 7 is denoted by the same reference marks, and the description thereof will be omitted. Note that, similarly to FIG. 1, motor drive control device 10 includes speed calculation unit 2, collision determination unit 3, and detector 4, which have the same configuration as that of FIG. 1, and thus illustration and description thereof are omitted.

Different from the first or third exemplary embodiment, the fifth exemplary embodiment is characterized in that a voltage generated by connection switching by control unit connection switcher 18 is directly used for input of connection state switching of short brake switch 20b.

For example, as illustrated in FIG. 8, pseudo load part 19 includes a rectifier circuit using diodes 19d to 19i and pseudo load resistor 19b. When control unit 6 and motor 7 are disconnected from each other by control unit connection switcher 18, a voltage is applied to both ends of short brake switch 20b by the voltage applied from control unit 6, and short brake switch 20b is turned on.

According to this configuration, the connection switching order of control unit connection switcher 18 and short brake switch 20b can be regulated, and short brake switch 20b can be prevented from being switched before the switching of control unit connection switcher 18.

In addition, since short brake switch 20b is turned on by directly using the voltage at short brake operation reference voltage point 20a, the short brake can be activated in a shorter time than a case where microcomputer 11 reads the voltage at short brake operation reference voltage point 20a and performs processing of turning on short brake switch 20b, and the time required for stopping the motor can be shortened.

### Sixth Exemplary Embodiment

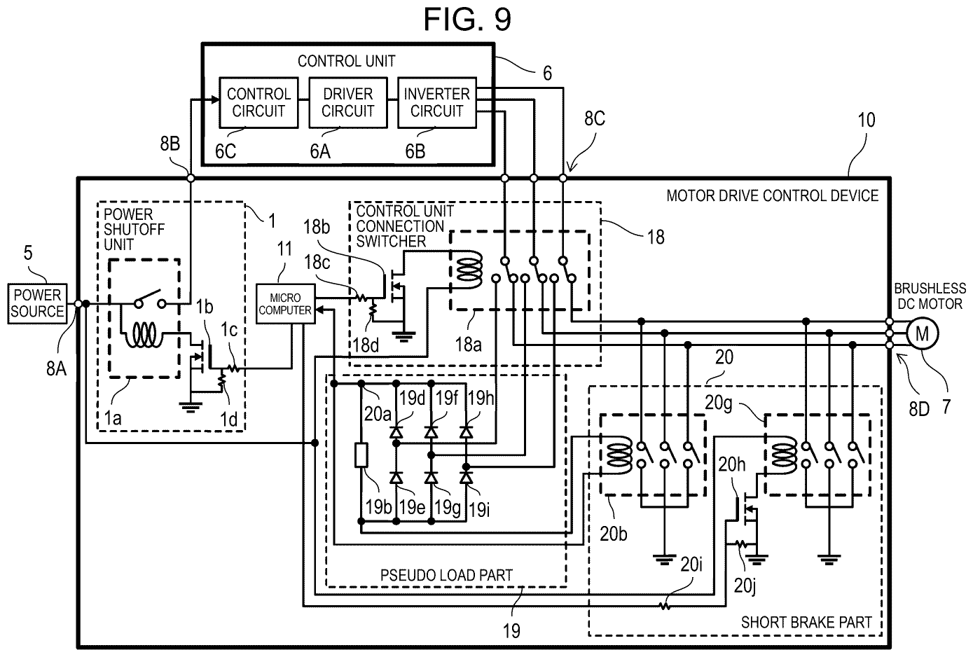

Next, a detailed configuration of motor drive control device 10 according to a sixth exemplary embodiment will be described. FIG. 9 is a system block diagram illustrating the motor drive control device of the sixth exemplary embodiment. In FIG. 9, the configuration same as that of FIG. 4, FIG. 7, or FIG. 8 is denoted by the same reference marks, and the description thereof will be omitted. Note that, similarly to FIG. 1, motor drive control device 10 includes speed calculation unit 2, collision determination unit 3, and detector 4, which have the same configuration as that of FIG. 1, and thus illustration and description thereof are omitted.

Different from the first, fourth, or fifth exemplary embodiment, the sixth exemplary embodiment is characterized in that microcomputer short brake switch 20g whose connection state is switched by microcomputer 11 is provided.

Short brake part 20 includes short brake switch 20b, microcomputer short brake switch 20g, NchMOSFET 20h, gate resistor 20i, and gate-source resistor 20j.

A voltage at short brake operation reference voltage point 20a is detected by an A/D converter of microcomputer 11. This voltage may be detected at a digital input port of the microcomputer using a comparator. Microcomputer 11 performs an output for turning on microcomputer short brake switch 20g according to the voltage value.

In the connection switching operation, it is desirable that microcomputer short brake switch 20g switch the connection of all three layers of the motor drive line by one input, and an example of realizing such an operation includes a relay switch of a three-pole a-contact or a three-pole c-contact.

The relay switch can be controlled by microcomputer 11 by, for example, connecting the HIGH side to the power source line, connecting the LOW side to the drain of NchMOSFET 20h, and connecting the gate of NchMOSFET 20h to microcomputer 11. Note that the power source line of microcomputer 11 and microcomputer short brake switch 20g is preferably connected between power source 5 and power shutoff unit 1 so as not to be shut off by power shutoff unit 1.

Microcomputer 11 continues the output for turning on microcomputer short brake switch 20g until it becomes a specified release state. Note that the specified released state is, for example, a case where power input from power source 5 to motor drive control device 10 is interrupted, a case where a short brake release signal is input from the inside or the outside of motor drive control device 10, a case where it is confirmed from a motor speed calculation result that the motor is stopped, or the like.

According to this configuration, even after the residual charge of control unit 6 is completely released and the output from control unit 6 to the motor drive line disappears, and the voltage of short brake operation reference voltage point 20a decreases and short brake switch 20b is turned off, microcomputer short brake switch 20g can maintain the state of being turned on, and by maintaining the connection state of short brake part 20, motor 7 can be stopped more quickly.

### INDUSTRIAL APPLICABILITY

The motor drive control device of the present disclosure functions only by connection between a power source line and a motor drive line, and can be widely used in products using a brushless DC motor such as a robot and an electric truck that require safety.

### REFERENCE MARKS IN THE DRAWINGS

10 motor drive control device
1 power shutoff unit
1a relay switch
1b NchMOSFET
1c gate resistor
1d gate-source resistor
2 speed calculation unit
2a current detector
2b voltage detector
2c speed calculator
3 collision determination unit
4 detector
5 power source
6 control unit
6A driver circuit
6B inverter circuit
6C control circuit
7 brushless DC motor
8A first input unit
8B first output unit
8C second input unit
8D second output unit
11 microcomputer
18 control unit connection switcher
18a relay switch
18b NchMOSFET
18c gate resistor
18d gate-source resistor
19 pseudo load part
19a pseudo load resistor
19d diode
20 short brake part
20a short brake operation reference voltage point
20b relay switch
20c NchMOSFET
20d gate resistor
20c gate-source resistor
20g microcomputer short brake switch
20h NchMOSFET
20i gate resistor
20j gate-source resistor

1. A motor drive control device that controls a motor with respect to a drive body driven by a control unit that receives power supply from a power source and controls the motor, the motor drive control device comprising:
a first input unit to which first current from the power source to the control unit is input;
a first output unit that outputs the first current input from the first input unit to the control unit;
a shutoff unit that is provided between the first input unit and the first output unit, and switches an output state of the first output unit;
a second input unit to which second current from the control unit to the motor is input;
a second output unit that outputs the second current input from the second input unit to the motor; and
an arithmetic unit that is provided between the second input unit and the second output unit, and calculates a rotation speed of the motor.

2. The motor drive control device according to claim 1, wherein the arithmetic unit determines a speed calculation method based on a value of the second current, and calculates the rotation speed of the motor by the determined speed calculation method.

3. The motor drive control device according to claim 1, wherein the arithmetic unit determines a speed calculation method based on a voltage value of the second current, and calculates the rotation speed of the motor by the determined speed calculation method.

4. The motor drive control device according to claim 2, wherein the arithmetic unit performs processing of determining the speed calculation method only once while the first current continues to be input.

5. The motor drive control device according to claim 1, further comprising:
a first switcher that switches a connection state between the second input unit and the second output unit; and
a short brake part that releases magnetic energy remaining in the motor,
wherein the short brake part includes a second switcher that switches a connection state between the short brake part and the second output unit.

6. The motor drive control device according to claim 5, wherein the second switcher switches the connection state between the short brake part and the second output unit by a voltage generated as a result of connection switching by the first switcher.

7. The motor drive control device according to claim 5, further comprising a load part serving as a resistor with respect to the second current,
wherein the first switcher connects the second input unit and the load part in a state where the second input unit and the second output unit are disconnected.

8. The motor drive control device according to claim 1, comprising a sensor unit that acquires environment information,
wherein the shutoff unit switches an output state of the first output unit based on the environment information acquired by the sensor unit and the rotation speed of the motor calculated by the arithmetic unit.
